(19) United States
(12) Patent Application Publication
(10) Pub. No.: US 2002/0186825 A1
(43) Pub. Date: Dec. 12, 2002

(54) Service management system blocking

(76) Inventors: Dean C. Marchand, Brighton, CO (US); Arthur Lance Springer, Waterloo, IA (US)

Correspondence Address: WORLDCOM, INC., TECHNOLOGY LAW DEPARTMENT, 1133 19TH STREET NW, WASHINGTON, DC, 20036, US

(21) Appl. No.: 09/875,083

(22) Filed: Jun. 6, 2001

(51) Int. Cl. H04M 3/00; H04M 3/42

(52) U.S. Cl. 379/188; 379/210.02

(57) ABSTRACT

A system and device for blocking fraudulent special service calls in a long distance telephone system is disclosed. The Automatic Number Identifiers (ANIs) of originating numbers within Local Exchange Carriers (LECs) are blocked from calling certain special service call numbers by including the ANI in the special service call number record in the long distance carrier's Service Management System (SMS) database. ANIs to be blocked are selected by fraud control based on certain network traffic flow thresholds. When the switching elements in the long distance carrier retrieve an SMS record for a particular special service call, it is determined whether the origin of the call corresponds to an ANI in the SMS record. If it does, the call is blocked.

### BACKGROUND

1. Technological Field

The present application relates generally to telecommunications and, in particular, to detecting and stopping fraudulent special service calls in a telecommunications network.

2. Description of the Related Art

A typical telecommunications network is made up of multiple telecommunications facilities located throughout a geographical area. When a user makes a call, that call may be routed through various facilities and switches before reaching its destination. The telephone number the user dials provides information about how to route the call.

As an example, consider a user making a long distance call. Typically, the user will dial a ten-digit number, such as 1-516-555-1234, which is known as the DDD (Direct Distance Dialing) number. The format of the DDD-number can be represented as 1-NPA-NXX-XXXX, where NPA (Number Area Plan) refers to the geographic location of the recipient, and NXX refers to the terminating exchange, identifying the central office switch where the call needs to be routed.

However, contemporary telecommunications networks provide many services beyond direct distance dialing. Long distance carriers provide special service call processing, such as “700”, “800” and “900” telephone calls, which provide customers with special services, like toll-free calls, calling card calls, special rate calls, etc.

The “800” number is an automated call routing service provided by long distance carriers. In general, “800” numbers allow call redirection features, such as conferencing, consultation, and blind transfer, to a caller. In its most well-known embodiment, the “800” number allows the user to reverse the charges so that the recipient pays the toll for the call, rather than the caller. The “800” service is invaluable to large corporations and other entities, because customer calls may be directed to any of a number of corporate locations in an efficient manner. When using this special “800” service, the caller dials a ten-digit number in the format 1-800-NXX-XXX. Since the “800” does not designate a particular geographical area, or, therefore, NPA, those first digits (“800”) are referred to as the service access code (SAC).

FIG. 1 is a schematic representation of the routing of a special service long distance telephone call using an “800” number. The call originates with the telephone 10 of a user and is routed through the Local Exchange Carrier (LEC) 20. LEC refers to local telephone companies, such as the Regional Bell Operating Companies (RBOCs). The LECs provide local transmission services for their customers. Long distance transmission of telephone calls is provided by an Inter-Exchange Carrier (IXC) 30, such as MCI-Worldcom. The IXCs interface with the LECs at Points-of-Presence (POPs) within the LECS. A POP is the physical location within the LEC wherein the IXC provides access to its long distance network. After switching through LEC switches 22 and 24, and it is determined that the call is an “800” number.

At this point, the serving LEC 20 must access a centralized Service Management System (SMS) database 100 to obtain routing information for the call. In FIG. 1, the centralized SMS is the Bellcore SMS 100 because the Bellcore SMS 100 serves as a centralized SMS for LECs. During this access, the LEC 20 checks to see if the originating Automatic Number Identifier (ANI) is blocked from calling the particular “800” number, as well as downloading information concerning routing of the call. In practice, the LEC 20 may keep its own SMS records that are periodically downloaded from the Bellcore SMS 100.

Once the LEC determines the proper routing information for the “800” call, the call is routed to the appropriate POP 25, which forwards the call into the appropriate IXC network at IXC Switch 31. The IXC Switch 31 signals a Service Switching and Control Point (SSCP) 41 with the dialed long distance “800” telephone number and the Automatic Number Identifier (ANI) of the caller. The SSCP 41 is part of the switching and routing control 40 used in the telecommunications network. An example would be the components of a Signalling System 7 (SS7) network, which are well-known in the art. The SSCP 41 receives and processes telephone calls, using an Intelligent Peripheral (IP) 42 to provide call processing applications. The SSCP also uses a Service Data Point (SDP) 45 for the storage and retrieval of data related to call processing. The SDP 45 is part of the IXC Service Management System (IXC SMS) 50, which provides network information, database management, and administrative support for the IXC network 30.

The IXC SMS 50 maintains and updates various service points whose primary responsibility is to respond to queries from switching points, such as IXC switches 31-34 and Bridge switch 35, for data required to complete routing of a call. The SSCP 41 retrieves and returns a routing number to the IXC switches 31-34, which use it to access a local routing table. The IXC switches 31-34 obtain specific routing information from the local routing table, and use that information to forward the call. For example, the call may hop through the IXC network 30 from IXC switch 31, through IXC switches 32 and 33, to IXC switch 34, where the call exits the IXC network 30. At that point, the call would enter LEC 60 at POP 65, from where it is switched through LEC switches 62 and 64, until it finally connects with telephone unit 70.

Although, in the example, there is one SDP, one SSCP, and several IXC switches, there is no limitation on the setup of the network infrastructure. For instance, several SSCP's may use a single SDP, or each IXC switch may have its own SSCP. The purpose of the schematic diagram of FIG. 1 is to give a broad overview of the components used in a telecommunications network. Only relevant components are addressed.

Special service calls may or may not require an Intelligent Service Network (ISN) platform to complete call processing. In FIG. 1, calls that require ISN platform 90 are routed to a Bridge Switch 35 within the IXC network 30. The ISN platform 90 performs the additional call processing that is required. For example, a calling card call would be routed to the ISN 90 so that the account number and Personal Identification Number (PIN) could be entered and compared with the database records. As shown in FIG. 1, the ISN 90 is connected to the switching and routing control 40 elements, in order to retrieve routing data, as well as the SMS 50, in order to retrieve network and billing information. An “800” calling card call may first be routed through the Bridge Switch 35 to the Automatic Call Distributor (ACD) 91, where calls being serviced by the ISN 90 are parked. There, the call is authorized and validated, and information is collected in order to correctly route and bill the call. Then the call is released back to the IXC network 30.

While beneficial in many respects, ironically the convenience of the “800” number system can be used to perpetuate fraud. One type of “800” number fraud is the unauthorized use of customer premise equipment (CPE), which will be described below. In some cases, a customer can incur fraudulent charges up to $100,000 over the course of a single weekend. To maintain good relations with the public, long distance carriers (IXCs) often assume the majority of liability for these calls. The losses due to CPE-related and other fraud are estimated to exceed $2 billion annually.

CPE-related fraud occurs when a third party gains illegal access to a customer's PBX (Private Branch eXchange) and steals the dial tone to make outgoing calls. Of course, “800” number are the preferred method of entrance into those PBXs, because even the call hacking into the system is free. The outgoing calls are charged to the CPE owner regardless of the origination of the call. From a financial standpoint, the worst and most costly form of abuse involves international calls.

An example of CPE-related “800” number fraud is shown in FIG. 2. The routing of the call from the hacker 200 through the two LECs is the same. As shown in FIG. 2, the call is routed through IXC switches 31, 32, 33, and 34 before reaching LEC 60, where it hops from LEC switch 64 to LEC switch 62 and lands at the PBX of the hacker's targeted victim. When the “800” number call reaches the PBX 250 of the corporate customer, the hacker 200 dials in the extension of someone the hacker 200 knows isn't there. Because the call goes unanswered, it is forwarded to the voice messaging system (VMS) 252. At this point, the hacker requests a call transfer, by, for example, pressing the “*” and “T” buttons on his phone. In some PBX systems, this activates a call transfer feature which prompts the hacker 200 to enter an extension number followed by the pound sign. The hacker responds by entering a trunk access code digit followed by the beginning digits of the phone number the hacker wishes to reach and, lastly, the pound sign. The PBX 250, in response to the starting trunk access code digit, selects an outgoing trunk line and dials the first digits. Once the hacker is connected to the trunk line, he dials in the remaining digits. In FIG. 2, the completed telephone number is of a telephone 299 in China. Thus, the call is routed out of the PBX, back through the LEC 60, through IXC switches 34 and 36, and terminates at telephone 299 in China. As far as the telephone system is concerned, that call is being placed from PBX 250, and not the hacker 200. So the billing records will indicate that the owner of PBX 250 made an expensive long distance call to China, and not the hacker 200.

Most fraudulent schemes leave tell-tale signs. For instance, when a hacker attempts the fraudulent scheme detailed above, she/he usually does not know the correct trunk access code for the PBX 250, so she/he repeatedly dials into the PBX 250 trying different digit combinations in order to get to the outside trunk line. So the network would see a long series of repeated short calls from a particular ANI to a particular “800” number in a short period of time. Most fraud control works by setting threshold values for such behavior: if there are more than a certain number of calls from a particular ANI to an “800” number in a short period of time, an alert is generated. The alert is either sent to a fraud analyst, who analyzes the behavior and determines whether to block future calls from that ANI to the “800” number, or an automated program that can make a similar determination. There are a variety of alerts for different behaviors. In the example above, if the hacker 200 successfully got into the PBX 250, the series of phone calls to China from that PBX might set off an alert.

Either an LEC or an IXC may discover fraudulent behavior and determine that an ANI should be blocked from calling a special service number. When the determination is made, the information is forwarded to the Bellcore SMS 100 (see FIG. 1). However, it takes a certain period of time for the information to be registered at the Bellcore SMS 100. And, even after being registered at the Bellcore SMS 100, it may take additional time for the information to filter down to the LEC 20, particularly if the LEC 20 maintains its own SMS database. The time difference between discovering fraudulent behavior and registering a blocked ANI can allow a hacker to successfully continue her/his activities.

One problem with this system is that the LEC is the guardian of the “800” gateway. Once the “800” call is authorized and validated by the LEC 20, the IXC network 30 merely routes the call and tracks billing information. But, as stated above, the fraud control unit in the IXC comes up with alerts and suspect originating ANIs before they are reported to the Bellcore SMS 100, which, in turn, reports them to the LEC 20. This means that while the fraudulent originating ANIs are going through the stages of the reporting system, more calls may be made from that originating ANI to the particular “800” number.

Therefore, a need exists for a system and method for preventing fraudulent special services calls more quickly and efficiently. Furthermore, the need exists for a system and method of detecting and stopping fraudulent “800” number calls from particular originating ANIs, without waiting for blocked originating ANI/“800” number combinations to be reported to the LEC.

### SUMMARY

One object of this invention is to provide an improved system and method of blocking fraudulent calls from particular originating ANIs in a telecommunications system.

Another object of this invention is to provide a system and a method for blocking originating ANIs from making particular “800” number calls in an IXC network in a telecommunications system.

To accomplish the above and other objects, a system and method for blocking fraudulent special service calls in a long distance telephone system is disclosed. The Automatic Number Identifiers (ANIs) of originating numbers within Local Exchange Carriers (LECs) are. blocked from calling certain special service call numbers by including the ANI in the special service call number record in the long distance carrier's Service Management System (SMS) database. ANIs to be blocked are selected by a fraud control analyst based on certain network traffic flow thresholds. When the switching elements in the long distance carrier retrieve an SMS record for a particular special service call, it is determined whether the origin of the call corresponds to an ANI in the SMS record. If it does, the call is blocked.

### BRIEF DESCRIPTION OF THE FIGURES

The foregoing and other objects, aspects and advantages will be better understood from the following detailed description of a preferred embodiment as illustrated in the following drawings. In the drawings, like reference numbers indicate identical or functionally similar elements.

FIG. 1 is a schematic diagram of the routing of a long distance telephone call, according to the prior art;

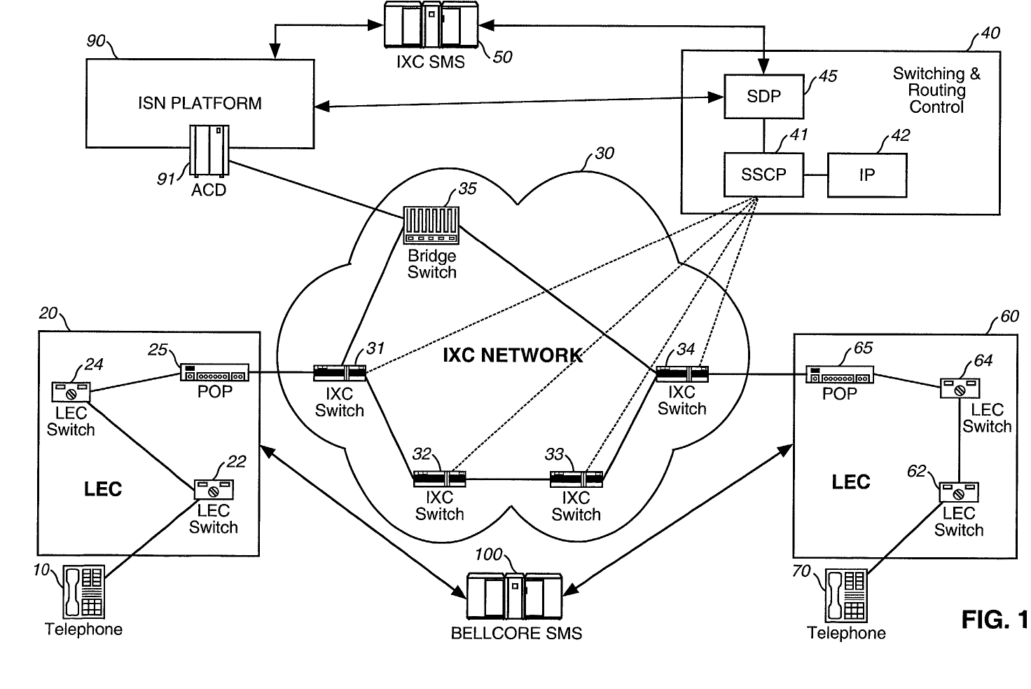

FIG. 2 is a schematic diagram of the routing of an exemplary fraudulent “800” number telephone call; and

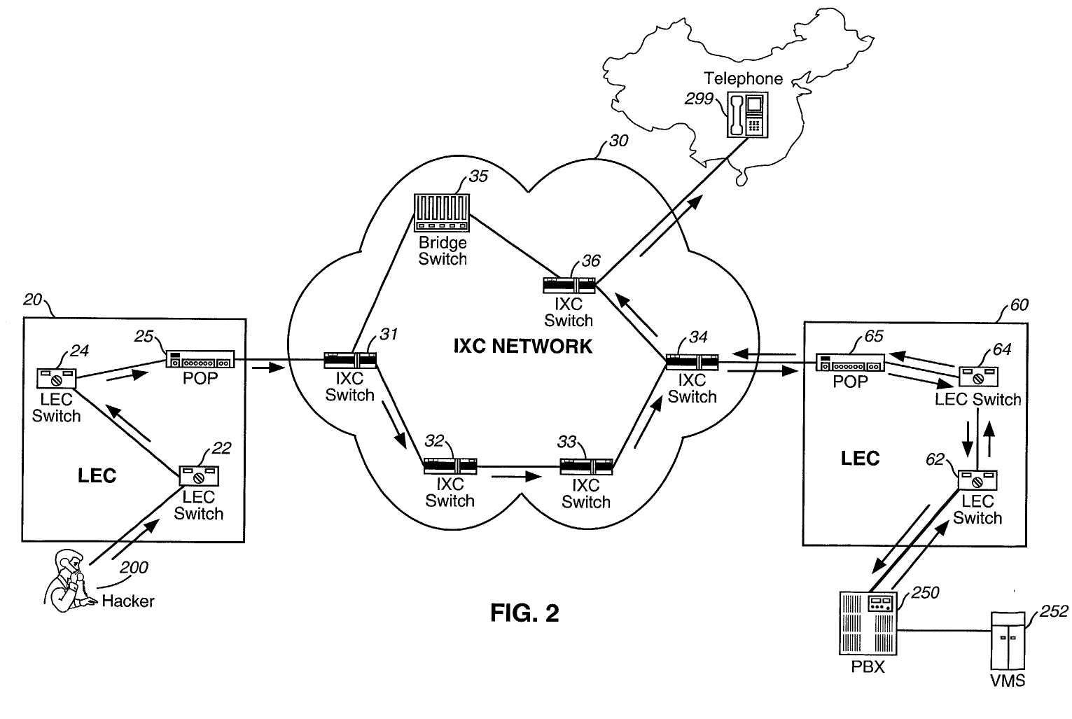

FIG. 3 is a schematic diagram of the routing of an exemplary fraudulent “800” number telephone call, according to the preferred embodiment of the present system and method.

### DETAILED DESCRIPTION OF THE PREFERRED EMBODIMENTS

In the following description, the term “network” is a short-hand description of the conglomeration of databases, trunk and telephone lines, routers, switches, protocols, and computers that are required to make a telecommunications network.

In short the preferred embodiment adds additional fields to the IXC SMS database so that particular originating ANIs are blocked from calling particular “800” numbers.

In the prior art, the IXC SMS 50 maintained routing and billing information concerning “800” number and other special services calls. In the preferred embodiment of the present invention, the IXC SMS records associated with “800” numbers have additional fields. For instance, the number “1-800-999-1111” will have an IXC SMS record that, besides containing routing and billing information, also contains an unlimited number of originating ANIs that are blocked from calling “1-800-999-1111”.

In the preferred embodiment of the present invention, call data records are continuously reviewed by IXC fraud control in order to detect patterns of fraudulent behavior. For calls to specific “800” numbers, the total number of short duration calls, the total number of long-duration calls, total number of calls of any type, and the total number of cumulative minutes from any type of call may be reviewed for suspicious patterns. In addition, risk factors may be assigned to calls from specific NPA-NXXs or countries. When an analysis of the different risk factors indicate that a specific originating phone number or ANI is a likely source of fraudulent behavior, that ANI is added to a “Bad ANI” field in the IXC SMS record of that particular “800” number. Thus, the fraudulent originating ANI is blocked from making further calls to that “800” number.

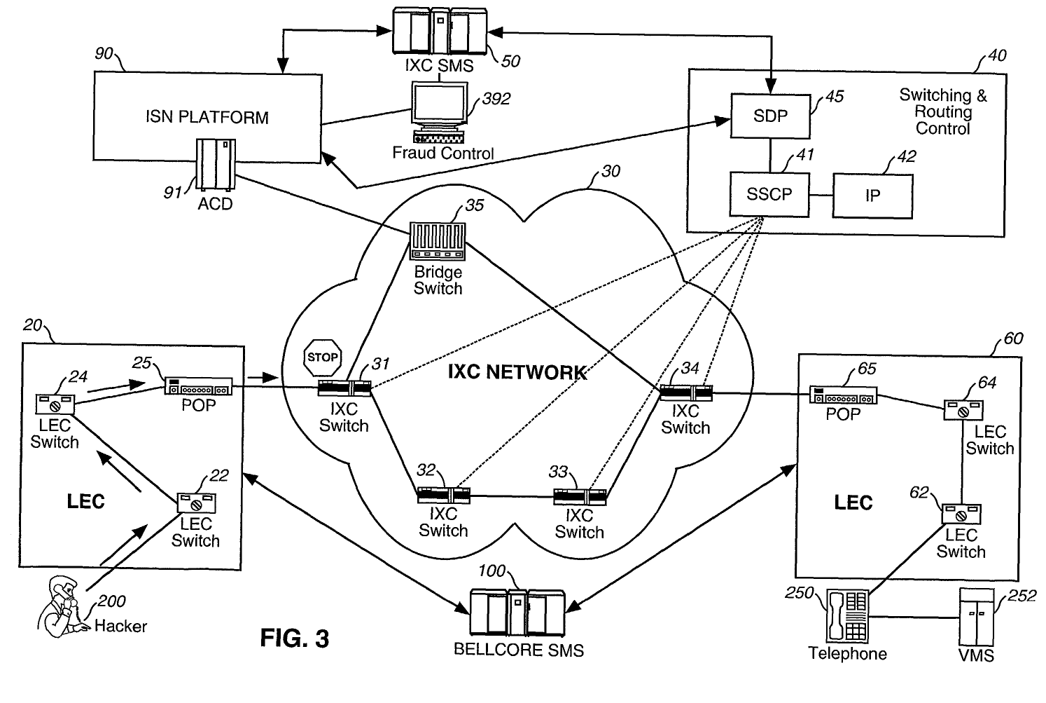

As an example, consider a hacker 200 attempting to access an outside trunk line of a PBX 250 in FIG. 3. Because the hacker usually doesn't know the correct outside trunk line access number, the hacker calls repeatedly, trying a new access code with each call. In this example, it is assumed the threshold for repeated short duration calls is forty (40). At the fortieth (40^{th}) call, a threshold alert goes off at fraud control 392, indicating suspicious activity. At this point, either a fraud analyst or an automated program reviews the history for that billing record and the originating ANI, and may conclude that a hacker is attempting to fraudulently access the PBX of the terminating “800” number. The fraud analyst or automated program enters the hacker's originating ANI in the “Bad ANI” field of the “800” number record in the IXC SMS. When the hacker attempts the forty-first (41^{st}) call, the IXC Switch 31 contacts SSCP 41 for routing information. The SSCP 41 queries the SDP 45, which, in turn, queries the IXC SMS 50 database. The IXC SMS reports that that particular originating ANI is blocked from calling that terminating “800” number. Subsequently, the IXC switch either tears down the call of forwards it to the ISN platform 90 for further investigation.

In the prior art, the fraudulent ANI would need to be reported to the Bellcore SMS 100, which would report it to the LEC 20. This could take a long enough period of time that the hacker might discover the outside trunk line access code before the LEC 20 blocks the “800” number from the hacker's ANI. The preferred embodiment of the present invention allows quick and efficient blocking of fraudulent “800” numbers.

As one skilled in the relevant art would recognize, many elements of a telecommunications network have been left out as irrelevant to the preferred embodiment of the present invention. These and other details have been left out in order not to obscure the invention in details unnecessary to the understanding of the present invention.

Although the above-described embodiment is the preferred embodiment, many modifications would be obvious to one skilled in the art. For instance, other methods for service and switching control could be used. The SS7 setup, with SSCPs and SCPs, would not be necessary to other embodiments of the invention. Furthermore, the ISN platform would not be necessary in other embodiments. In another embodiment, the fraudulent ANI may be stored in another database which is used when routing special service calls, rather than the SMS.

While the present invention has been described with respect to a certain preferred embodiment, it should be understood that the invention is not limited to this particular embodiment, but, on the contrary, the invention is intended to cover all modifications, equivalents, and alternatives falling within the spirit and scope of the invention as defined by the appended claims.

What is claimed is

1. A method for preventing special service call fraud in a telephone network comprising the steps of:
a) maintaining at least one record, each record associated with a special service call number;
b) adding an originating number identification to a record; and
c) blocking all calls to a terminating special service call number, when an origin of the special services call is indicated by the originating number identification in the record associated with said special service call number.

2. The method as recited in claim 1, wherein the at least one record of step (a) is maintained in a Service Management System (SMS) database.

3. The method as recited in claim 1, wherein the originating number identification is an Automatic Number Identification (ANI).

4. The method as recited in claim 1, wherein the termininating special service call number is an “800” number.

5. The method as recited in claim 1, wherein step (b) further comprises the steps of:
selecting at least one threshold for suspicious activity;
monitoring calls on the network;
placing the originating number identification in the record of a terminating special services call, when network activity associated with the originating number surpasses said at least one threshold in relation to the terminating special services call.

6. A method for preventing special service call fraud in a long distance telephone system, said telephone system connected to Local Exchange Carriers (LECs) for carrying local telephone traffic, comprising the steps of:
a) maintaining at least one record, each record associated with a terminating special service call number;
b) adding an identification of a number originating in a LEC to a record; and
c) blocking all calls to a terminating special service call number, when an origin of the special services call is indicated by the originating number identification in the record associated with said special service call number.

7. The method as recited in claim 6, further comprising the step of:
routing the special service calls through the long distance telephone system to a bridge switch, said bridge switch being under the control of a call processing platform, said call processing platform performs the blocking of step (c).

8. The method as recited in claim 6, further comprising the step of:
routing the special service calls through the long distance telephone system using at least automated switch, said automated switch under the control of an automatic switching and routing control system.

9. The method as recited in claim 8, wherein the automatic switching and routing control system is Signaling System 7 (SS7).

10. A device for preventing special service call fraud in a telephone system, comprising:
a database for maintaining at least one record, each record associated with one special service call number;
means for entering originating number identifications into said records; and
means for blocking a special service call, said special service call having an originating number corresponding to an originating number identification in the special service call number record.

11. The device as recited in claim 10, wherein the means for blocking further comprises:
means for retrieving and storing said records from said database;
means for contacting said means for retrieving and storing, for extracting information from said means for retrieving and storing, and for sending said information to at least one switch; and
at least one switch for switching calls, for receiving said information from said means for contacting, and for blocking special service calls when said information indicates to do so;
wherein, when a special service call is made from an originating number to a corresponding special service call number, and a record for the corresponding special service call number has an originating number identification corresponding to said originating number, the information sent to the at least one switch indicates to block the special service call.

12. The device as recited in claim 11, wherein the database is a Service Management System (SMS) database, the means for retrieving is a Service Control Point (SCP), and the means for contacting is a Service Switching and Control Point (SSCP), in a Signalling System 7 (SS7) network.

13. The device as recited in claim 10, wherein the means for blocking further comprises:
an Intelligent Services Network (ISN) platform for retrieving and storing said records from said database; and
an Automatic Call Distributor (ACD), under control of the ISN platform, for routing and switching special service calls, and for blocking special service calls, when said special service calls have an originating number that corresponds to an originating number identification in a special service call number record.

14. The device as recited in claim 10, wherein the means for entering originating number identifications into said records further comprises:
a fraud control console;
wherein alerts are generated when network traffic exceeds at least one threshold, and said generated alerts are reported to said fraud control console.

15. The device as recited in claim 10, wherein the means for entering originating number identifications into said records further comprises:
an automated fraud control program for determining whether an originating number identification should be entered into said records when network traffic exceeds at least one threshold.

16. The device as recited in claim 10, wherein the database for maintaining at least one record is a Service Management System (SMS) database.

17. The device as recited in claim 10, wherein the special service call number is a “800” number.

18. The device as recited in claim 10, wherein the originating number identification is an Automatic Number Identification (ANI).

19. The device as recited in claim 10, wherein the telephone system comprises at least one Local Exchange Carrier (LEC) and an Inter-exchange Carrier (IXC).

20. The device as recited in claim 19, wherein the IXC includes the database for maintaining at least one record, the means for entering originating number identifications, and the means for blocking a special service call; and the at least one LEC has at least one originating number.
